(19) United States
(12) Patent Application Publication
(10) Pub. No.: US 2018/0147985 A1
(43) Pub. Date: May 31, 2018

(54) VEHICLE PROJECTION SYSTEM

(71) Applicant: CORNING INCORPORATED, CORNING, NY (US)

(72) Inventors: Gordon Charles Brown, Rock Stream, NY (US); Joshua Monroe Cobb, Victor, NY (US); Kevin Thomas Gahagan, Painted Post, NY (US); James Andrew West, Painted Post, NY (US)

(21) Appl. No.: 15/578,103

(22) PCT Filed: Jun. 1, 2016
(86) PCT No.: PCT/US16/35148

§ 371 Date: Nov. 29, 2017

Related U.S. Application Data
(60) Provisional application No. 62/169,800, filed on Jun. 2, 2015.

(51) Int. Cl. B60R 1/00; B60R 16/037; B60K 35/00; G03B 21/20; G03B 17/54; H04N 5/232; H04N 9/31; G06F 3/01

(52) U.S. Cl. CPC B60R 1/00; B60K 2350/2052; B60K 35/00; G03B 21/2013; G03B 21/2033; G03B 21/2093; G03B 17/54; H04N 5/23293; H04N 9/3147; H04N 9/3161; G06F 3/013; B60R 2300/20; B60K 2350/1072; B60K 2350/2013; B60K 2350/2047; B60R 16/037

(57) ABSTRACT

The present technology relates to a vehicle projection system comprising a light source configured to provide an output beam. A light splitting device is coupled to the light source to receive the output beam. Two or more optical fibers are coupled to the light splitting device to receive a split output beam from the light splitting device. Two or more projector devices are coupled to the two or more optical fibers. The two or more projector devices are configured to provide one or more display images using light received from the split output beam on one or more display surfaces in a vehicle. A vehicle including the vehicle projection system and a method of providing display images at a plurality of locations in a vehicle are also disclosed.

This application claims the benefit of priority to U.S. Application No. 62/169,800 filed on Jun. 2, 2015 the content of which is incorporated herein by reference in its entirety.

### FIELD

The present technology relates to a vehicle projection system, a vehicle containing the vehicle projection system, and a method of using the system to provide display images at a plurality of locations in a vehicle.

### BACKGROUND

With the proliferation of smart phones and other internet connected devices, people are increasingly able to access information at various locations, leading to a more connected lifestyle. There is a desire to maintain this connected lifestyle while travelling. Accordingly, today's vehicles incorporate numerous displays, such as interactive consoles, dashboard displays, or video screens, which provide passengers with access to information, entertainment, etc. Certain displays may also be employed to increase the overall safety of the vehicle, such as, for example, providing necessary warnings. Vehicle designers are looking to new display technology to enhance vehicle safety and comfort, while providing the desired connected lifestyle.

The increasing number of display devices in vehicles leads to a number of drawbacks. The greater number of electronic displays and devices can lead to an increased need for service of the devices to maintain them in working order. The increased number of devices can also create a nuisance among individual passengers whose vision may be directed to different devices simultaneously. More importantly, the displays may create a distraction for the operator of the vehicle. Additionally, the displays may simply detract from the overall appearance of the inside of the vehicle.

The present invention is directed to overcoming these and other deficiencies in the art.

### SUMMARY

One aspect of the present invention relates to a vehicle projection system comprising a light source configured to provide an output beam. A light splitting device is coupled to the light source to receive the output beam. Two or more optical fibers are coupled to the light splitting device to receive a split output beam from the light splitting device. Two or more projector devices are coupled to the two or more optical fibers. The two or more projector devices are configured to provide one or more display images using light received from the split output beam on one or more display surfaces in a vehicle.

Another aspect of the present invention relates to a vehicle including the vehicle projection system. One or more display surfaces are configured to receive one or more display images from the two or more projector devices.

A further aspect of the present invention relates to a method of providing display images in a vehicle. The method includes providing the vehicle projection system. The output beam is split among the two or more optical fibers. The split output beam is directed to the two or more projection devices through the two or more optical fibers. The one or more display images are selectively provided to the one or more display surfaces in the vehicle using light received from the output beam.

The present technology advantageously provides a vehicle projection system utilizing a single light source to provide displays at various locations within a vehicle. The use of a single light source provides enhanced serviceability of the system while reducing overall cost. The present technology further advantageously provides sufficient optical throughput to generate display images in sunlight. The vehicle projection system allows for selective placement of displays in order to enhance comfort and safety. For example, placing display information closer to a driver's line of sight increases safety, while decreasing cost and complexity of dashboard design.

### BRIEF DESCRIPTION OF THE DRAWINGS

FIG. 1 is a block diagram of an exemplary vehicle projection system.

FIG. 2 is top phantom view of an exemplary vehicle including an exemplary vehicle projection system.

FIG. 3 is a top phantom view of the exemplary vehicle of FIG. 2 with the projector devices providing one or more display images on exemplary display surfaces of the vehicle.

### DETAILED DESCRIPTION

The present technology relates to a vehicle projection system, a vehicle including the vehicle projection system, and a method of providing display images at a plurality of locations in a vehicle.

One aspect of the present disclosure relates to a vehicle projection system comprising a light source configured to provide an output beam. A light splitting device is coupled to the light source to receive the output beam. Two or more optical fibers are coupled to the light splitting device to receive a split output beam from the light splitting device. The optical fibers can be configured as optical waveguides or light pipes. Two or more projector devices are coupled to the two or more optical fibers. The two or more projector devices are configured to provide one or more display images using light received from the split output beam on one or more display surfaces in a vehicle.

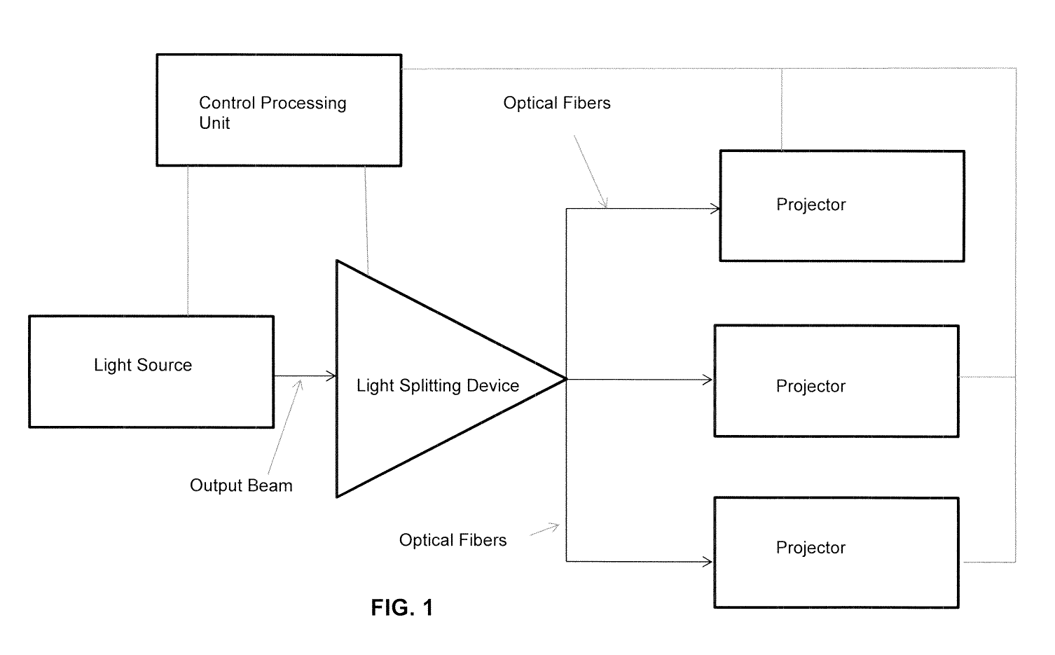

One embodiment of a vehicle projection system is illustrated in FIG. 1. The vehicle projection system includes a light source, two or more optical fibers, a light splitting device, two or more projector devices, and a control processing unit, although the vehicle projection system may include other numbers of devices or elements in other configurations. The vehicle projection system of the present technology advantageously provides for selective display on various surfaces of a vehicle using a single light source. The vehicle projection system may be employed in any type of vehicle, such as cars, trucks, buses, boats, RV's, aircraft, etc., although other uses of the projection system may be contemplated.

The vehicle projection system includes a light source configured to provide an output beam. In various embodiments, the output beam can be collimated or non-collimated. The light source is located in a single location in a vehicle in an area accessible for servicing the light source, such as by way of example only, the trunk of the vehicle. In one example, the light source is a laser, such as a distributed Bragg reflector (DBR) laser, distributed feedback (DFB) laser, vertical cavity surface emitting laser (VCSEL), diode pumped solid state laser (DPSS), native green laser, vertical external cavity surface-emitting laser (VECSEL), or Fabry-Perot laser, although other types of lasers may be utilized. Various types of lasers with different wavelengths may be utilized, alone or in combination, to provide the output beam. Other non-solid state types of lasers, such as gas, tunable dye, or fiber lasers could alternately be used. In another example, the light source includes one or more solid state light sources, such as an array of light emitting diodes, by way of example only, to provide the output beam. The light source is configured to provide sufficient output power to generate a sunlight readable image from the projector devices. The power of the light source output may be selected based on the display application.

In yet another example, the light source may be a composite light source comprising one or more individual light sources that are operable to emit coherent light beams having wavelengths in the green, blue, and red portions of the visible spectrum, respectively, although more or fewer light sources may be utilized in the composite light source.

The output beam (or output beams for a composite source) may be combined and collimated with various optical components, such as lenses and mirrors, to produce a collimated output beam for use in the vehicle projection system. The light source may be located in a housing including the optical components as well as heat management and cooling components.

In one embodiment, the light source may be operated in conjunction with a scanning projector device to reduce speckle and image flicker in the projected images from the projector devices as disclosed, for example, in U.S. Pat. No. 8,585,206 to Gollier, the disclosure of which is hereby incorporated herein by reference in its entirety.

The light source is coupled to a light splitting device, such as an optical splitter or an optical multiplexer, although other light splitting devices may be utilized. In an exemplary embodiment, the light splitting device is an optical splitter coupled to the light source to receive the output beam from the light source and to split the output beam. The optical splitter may include an active or passive switch to split the output beam among various projector devices. Different switching technologies that can be used for switching light between the optical paths include micro-electromechanical systems (MEMS) devices, such as components that use a digital micromirror array or an optical grating array. Acousto-optical modulators (AOMS) and electro-optical modulators (EOM) could alternately be used within the optical splitter. The optical splitter may be coupled to the control processing unit, such as a computer or microprocessor for controlling timing of the switching performed by the optical splitter.

In another embodiment, the light splitting device is an optical multiplexer. In one example, the optical multiplexer functions as described in U.S. Pat. No. 8,444,272 to Cobb, the disclosure of which is incorporated herein by reference in its entirety. Time division multiplexing may be utilized, for example, as described in U.S. Pat. No. 8,444,272, to split the output beam among the projector devices, although other multiplexing techniques may be employed.

The division of the light among the projector devices is controlled by the control processing unit. The light splitting device may be utilized to split the output beam from the light source unequally depending on the display (i.e., light output) requirements of the various projector devices.

One of the advantages of using the optical multiplexer for switching the same light source to different projectors is that the light source itself is not switched repeatedly on and off, but remains on continuously during projector operation. Repeated on/off switching of solid-state or other light sources shortens component life. In addition, for some types of emissive devices, there may be an initial settling time needed, such as for wavelength stability, each time the device is turned on. The need for this settling time is eliminated by maintaining the light source in the energized state and sequentially switching to different projectors. Another significant advantage relates to efficiency and resulting brightness that may be achieved.

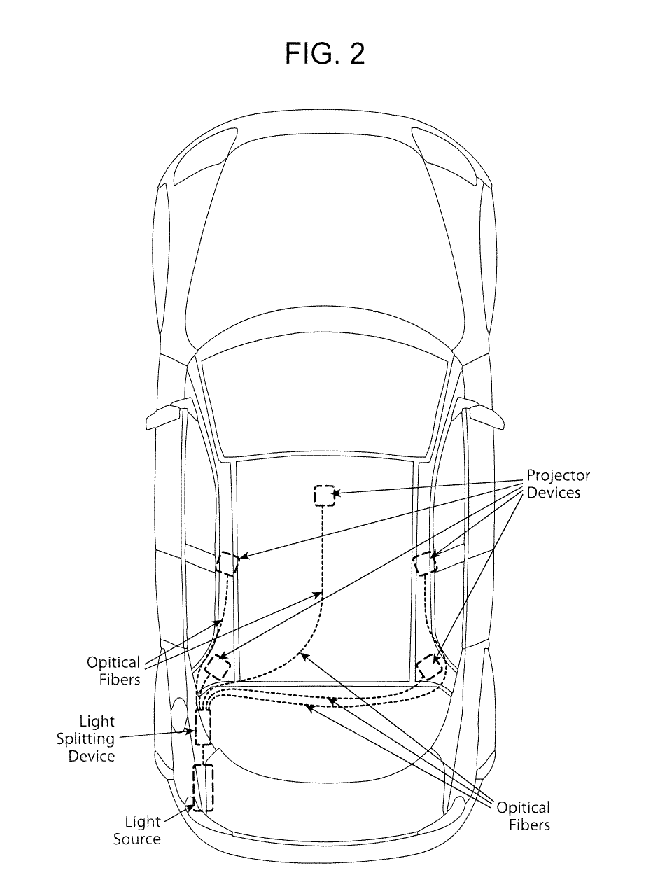

The split output beam is delivered from the light splitting device to the projector devices via fiber optic cables. In one example, the fiber optic cables are configured to reduce sparkle in the displayed image. In another example, the fiber optic cables are multimode fibers. In yet another example, the optical fibers may be light diffusing fibers, such as Fibrance™ fibers produced by Corning Incorporated to provide combined lighting and display features. In a further example, the optical fibers are capable of handling high optical power density in the visible range of wavelengths. The optical fibers may route the beam selectively provided from the light splitting device through the vehicle to the multiple projector devices as illustrated in FIG. 2. In one example, the vehicle projection system may further include an interlock system to shut off a laser light source in the event of optical fiber breakage or fume detection within the vehicle.

Referring more specifically to FIG. 2, the projector devices are positioned at various locations in the vehicle and configured to provide a display image on a surface of the vehicle using the received split output beam from the light splitting device. The display images may include, by way of example only, navigation related images such as map displays, road hazard warnings, displays of vehicle instruments such as the speedometer or odometer, lighting features, design features, images from outside or inside of the vehicle, etc. Various other display images that may be formed using the projector devices are contemplated using the present technology.

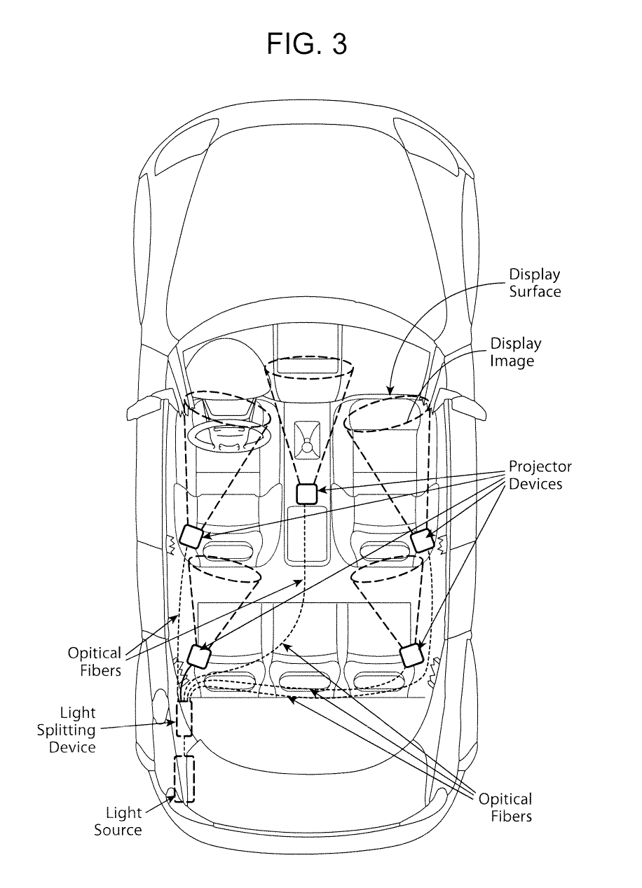

The projector devices are positioned based on the desired display surface for the projected image and to avoid interference with the displayed image by passengers within the vehicle as illustrated in FIG. 3. Numerous locations for the projector devices throughout the vehicle may be contemplated. The projector devices may further be positioned to provide specific viewing angles for specific passengers of the vehicle.

By way of example only, the projector devices may be digital light processing device (DLP) projectors, although other types of projector devices, such as microprojectors liquid crystal on silicon (LCOS), or LCD projectors, may be utilized.

In one example, multiple projector devices are located within the vehicle to provide a display image at a designated display surface of the vehicle. By way of example, the display surfaces may include a windshield, a window, a mirror, a pillar, a side panel of a door, a headrest, a dashboard, a console, a seat of the vehicle, or any portion thereof, although other surfaces within the vehicle may be utilized.

In some examples, the display surface is at least partially transparent to visible light. Ambient light (e.g., sunlight from outside the vehicle) may make the display image difficult or impossible to see when projected on such a display surface. In some examples, the display surface, or portion thereof on which the display image is projected, can include a darkening material such as, for example, an inorganic or organic photochromic or electrochromic material, a suspended particle device, and/or a polymer dispersed liquid crystal. Thus, the transparency of the surface can be adjusted to increase the contrast of the display image provided at the display surface. For example, the transparency of the display surface can be reduced in bright sunlight by darkening the display surface to increase the contrast of the display image. The adjustment can be controlled automatically (e.g., in response to exposure of the display surface to a particular wavelength of light, such as ultraviolet light, or in response to a signal generated by a light detector, such as a photoeye) or manually (e.g., by viewer such as a passenger in a vehicle).

In another example, one or more scanning projector devices may be utilized to provide the display images at various locations within the vehicle from a single projector. In one embodiment, a single projector device may be utilized that is capable of scanning the entire interior of the vehicle to provide a display on a number of vehicle surfaces.

In one embodiment, each projector device directs the portion of the output beam received from the light source (for example, through the optical multiplexer) to a spatial light modulator that is energizable to form an image from the received light, using the illumination that is provided through the optical fiber to which the projector device is coupled.

In one embodiment, the projector devices include a speckle reduction adjustable optical component and a scanning adjustable optical component as described, for example, in U.S. Patent Application Publication No. 2012/0013812 to Gollier, the disclosure of which is hereby incorporated herein by reference in its entirety. The speckle reduction and scanning adjustable optical components may comprise one or more controllable and movable micro-opto-electromechanical systems (MOEMS) or micro-elecrto-mechanical systems (MEMS). It is also contemplated that the MOEMS or MEMS be operatively coupled to a mirror or a prism that is configured to redirect the light beam accordingly.

In another embodiment, the projector devices may include a light modulator that is configured to selectively provide the display image. By way of example, the light modulator may modulate the received light to black in order to turn the display image from that projector device “off.” For a scanning projector device, the received light may be modulated to black until the desired display surface is reached and then the light could be modulated to provide the image. The projector devices may be utilized to provide displays at different times or at different locations in the vehicle, or may be utilized all at once. The light modulators may be, by way of example only, digital micromirror arrays, a liquid-crystal device, or a scanned linear diffraction grating.

The projectors may be configured to provide various types of displays depending on the specific display requirements. The projector devices may be coupled to the control processing unit which may control the image formation by the projector devices.

The projector devices may further provide an interactive display as described, for example, in U.S. Patent Application Publication No. 2011/0267262 to Gollier, the disclosure of which is hereby incorporated herein by reference in its entirety. In some embodiments, the projector device includes a detection device that collects light and determines changes in the collected light based on the presence of an object, such as a pointer or a finger, located in the illuminated area of the display image with different light scattering properties than the display surface. Thus, the detection device determines changes in the power of the collected light that may be provided to the control processing unit for further processing. The detection device may be utilized for various interactive display methods, although other devices or systems may be utilized to provide interactive displays from the one or more projector devices. In other embodiments, the display surface comprises a touch surface, e,g., similar to a touch surface used on a conventional consumer electronics device.

The control processing unit includes a processor, a memory, and a communication interface, all of which are coupled together by a bus or other link, although other numbers and types of components, parts, devices, systems, and elements in other configurations and locations can be used. The processor in the control processing unit executes a program of stored instructions for one or more aspects of the present disclosure as described and illustrated by way of the embodiments described herein, although the processor could execute other numbers and types of programmed instructions. The processor may include one or more central processing units or general purpose processors with one or more processing cores, for example.

The memory in the control processing unit stores these programmed instructions for one or more aspects of the present disclosure as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory.

The communication interface in the control processing unit is used to operatively couple and communicate between the control processing unit and one or more other computing devices via a communication network, although other types and numbers of communication networks with other types and numbers of connections and configurations can be used. The communication network can include one or more local area networks (LANs) and/or wide area networks (WANs). By way of example only, the communication networks can use TCP/IP over Ethernet and industry-standard protocols, including hypertext transfer protocol (HTTP) and/or secure HTTP (HTTPS), for example, although other types and numbers of communication networks also can be used. By way of example only, the control processing unit may communicate with an onboard vehicle computer or one or more user devices to obtain information to be displayed by the projector devices.

In one example, the vehicle projection system further includes one or more cameras coupled to the projector devices or to the control processing unit such that data from the cameras (e.g., image data) can be transmitted to and/or received by the projector devices or the control processing unit. The one or more cameras may be positioned to capture images of an environment outside of the vehicle. In one example, a camera may be positioned to image an area outside of the vehicle that would normally be blocked by a pillar of the vehicle. The camera may image that area and provide the images to a projector device for display on the inside surface of the pillar, thereby improving the driver's overall field of view. In another example, one or more cameras may be positioned to image an area inside of the vehicle, such as obtaining images of children in the back seat of the vehicle, by way of example only. These images may be provided to a projector device viewable by a passenger in the front of the vehicle in order to monitor the children in the back of the vehicle. Various other uses for the one or more cameras in conjunction with the vehicle projection system may be contemplated. In one example, images from two cameras may be fed to a single projector device (or multiple projector devices) for display at a display surface as an autostereoscopic image.

In another embodiment, the vehicle projection system further includes an eye location tracking device coupled to one or more of the projector devices or the control processing unit. The eye location tracking device is positioned to track and determine the eye position of a passenger in the vehicle. The eye location tracking device determines the eye position and transmits the information to either the individual projector device or the control processing unit. The scanning element in the projector device is then altered to provide the display image at a specific viewing angle corresponding to the eye position of the passenger. In one example, a display image is moved from a first display surface to a second display surface that is different than the first display surface in response to a change in a detected eye position. Thus, the display image can be moved to a location (i.e., a particular display surface) corresponding to where the viewer is looking.

Another aspect of the present disclosure relates to a vehicle including the vehicle projection system. One or more display surfaces are configured to receive one or more display images from the two or more projector devices.

The vehicle employing the vehicle projection system may employ surfaces specifically adapted for particular display applications. By way of example, the display surfaces may include a windshield, a window, a mirror, a pillar, a side panel of a door, a headrest, a dashboard, a console, or a seat of the vehicle, or any portions thereof, although other surfaces within the vehicle may be utilized.

In one embodiment, the display surfaces of the vehicle may be modified with various diffractive elements in order to restrict viewing angle. The viewing angle may be restricted, by way of example, to provide displays for passengers that will not distract the driver of the vehicle, or such that individual passengers may have their own displays. In another example, a single display surface may provide different display images to two or more different viewing angles (e.g., by projecting the different display images onto different sets of diffractive elements of the display surface. Additional modifications to the display surfaces may be made to accommodate other display applications. In one example, the display surface may be combined with a speaker in order to provide sound with the display, as well as to reduce sparkle in the displayed image. For example, the vibration of the display surface that results from acoustic waves traveling through the display surface can help to reduce sparkle in the displayed image. In another example, the display surfaces are configured to be capable of displaying autostereoscopic images, such as projection onto a lenticular film. In yet another example, a speckle reduction diffusing surface may be placed in the optical path prior to the display surface to reduce speckle as described in U.S. Pat. No. 8,678,599 to Gollier, the disclosure of which is hereby incorporated herein by reference in its entirety.

A further aspect of the present disclosure relates to a method of providing display images at a plurality of locations in a vehicle. The method includes providing the vehicle projection system. The output beam is split among the two or more optical fibers. The split output beam is directed to the two or more projection devices through the two or more optical fibers. The one or more display images are selectively provided to the one or more display surfaces in the vehicle using light received from the output beam.

In operation, the light source provides an output beam. The output beam is split or multiplexed by the light splitting device in order to be provided among two or more projector devices through optical fibers. The output beam may be split selectively among the projector devices to provide light only to those display devices being employed. Further, the power of the output beam may be split unequally among the projector devices depending on the display application to be employed by each of the projector devices. For example, a projector that will show a text only display, such as an image of the speed at which the car is travelling may require less power than a projector utilized to display a video. Thus, an optical multiplexer may be utilized in one embodiment to optically distribute the optical power to the projector devices based on the display applications. Additionally, or alternatively, an optical multiplexer may be utilized in one embodiment to optically distribute the optical power to the projector devices based on the presence of a safety or other warning condition. For example, the multiplexer can increase the power to a projector selected to show a safety or other warning image (e.g., to indicate the presence of an object such as a pedestrian or vehicle in a vehicle's path) at the expense of other projectors showing less urgent images (e.g., entertainment images).

The projector devices receive the light from the light source and provide one or more display images on a display surface. The image provided by the projector devices may be controlled by the control processing unit, by way of example. The control processing unit may receive data from other devices, such as an onboard vehicle computer, a smart phone, one or more cameras, etc. to be displayed at one or more display surfaces in the vehicle. Various display applications are contemplated using the present technology. In one embodiment, the display may be an interactive display that responds to the position of a user's finger or a pointer.

Although projection systems are described herein for use in vehicles, other embodiments are included in this disclosure. In various embodiments, display surfaces described herein can be incorporated into vehicles such as automobiles, boats, and airplanes (e.g., mirrors, pillars, side panels of a door, headrests, dashboards, consoles, or seats of the vehicle, or any portions thereof), architectural fixtures or structures (e.g., internal or external walls or flooring of buildings), appliances (e.g., a refrigerator, an oven, a stove, a washer, a dryer, or another appliance), consumer electronics (e.g., televisions, laptops, computer monitors, and handheld electronics such as mobile phones, tablets, and music players), furniture, information kiosks, retail kiosks, and the like. Thus, the projection systems can be used to display images on display surfaces for a variety of different applications.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. A vehicle projection system comprising:
a light source configured to provide an output beam;
a light splitting device coupled to the light source to receive the output beam;
two or more optical fibers coupled to the light splitting device to receive a split output beam from the light splitting device; and
two or more projector devices each coupled to at least one of the two or more optical fibers, the two or more projector devices configured to provide one or more display images using light received from the output beam on one or more display surfaces in a vehicle.

2. The vehicle projection system of claim 1, wherein the light source comprises one or more lasers or solid state light sources.

3. (canceled)

4. The vehicle projection system of claim 1, wherein the light splitting device comprises an optical splitter or an optical multiplexer.

5. (canceled)

6. The vehicle projection system of claim 1, wherein the light splitting device is configured to split the output beam unequally based on display requirements for the two or more projector devices.

7. The vehicle projection system of claim 1, wherein each of the two or more projector devices comprises a light modulator configured to selectively provide the display image, and the light modulator is selected from the group consisting of a digital micromirror array, a liquid-crystal device, and a scanned linear diffraction grating.

8. The vehicle projection system of claim 1, wherein at least one of the two or more projector devices comprises a scanning laser projector configured to provide a display image on a plurality of display surfaces of the vehicle.

9. The vehicle projection system of claim 1, wherein the one or more display surfaces comprise one or more of a windshield, a window, a mirror, a pillar, a side panel of a door, a headrest, a dashboard, a console, a seat, or any portion thereof, of the vehicle.

10. The vehicle projection system of claim 1, further comprising one or more cameras coupled to the two or more projector devices, the one or more cameras positioned to capture images for display on at least one of the one or more display surfaces of the vehicle.

11. The vehicle projection system of claim 1, further comprising an eye location tracking device coupled to the two or more projector devices, the eye location tracking device configured to determine a viewing angle for at least one passenger in the vehicle, wherein at least one of the two or more projector devices provides the display image based on the determined viewing angle.

12. The vehicle projection system of claim 1, wherein at least one of the two or more projector devices is coupled to a vehicle onboard computer to receive one or more items of data related to the vehicle from the vehicle onboard computer for display in the display image.

13. The vehicle projection system of claim 1, wherein at least one of the two or more projector devices further comprises a detection device configured to detect user movement with respect to the display image.

14. (canceled)

15. A vehicle comprising the vehicle projection system of claim 1.

16. A method of providing display images in a vehicle comprising the vehicle projection system of claim 1, the method comprising:
splitting the output beam among the two or more optical fibers;
directing the split output beam to the two or more projection devices through the two or more optical fibers; and
selectively projecting the display images to the one or more display surfaces in the vehicle using light received from the split output beam.

17. The method of claim 16, wherein the splitting further comprises splitting the at least one output beam unequally based on display requirements for the two or more projector devices.

18. (canceled)

19. The method of claim 16 further comprising:
tracking an eye location of at least one passenger in the vehicle using an eye location tracking device;
determining a viewing angle for the at least one passenger in the vehicle based on the tracked eye location; and
providing the display image from at least one of the two or more projectors based on the determined viewing angle.

20. A vehicle projection system comprising:
a light source configured to provide an output beam;
a projector device coupled to the light source, the projector device configured to provide one or more display images using light received from the output beam on at least two different display surfaces in a vehicle.

21-22. (canceled)

23. The vehicle projection system of claim 20, wherein the projector device comprises a light modulator configured to selectively provide the display image, and the light modulator is selected from the group consisting of a digital micromirror array, a liquid-crystal device, and a scanned linear diffraction grating.

24. (canceled)

25. The vehicle projection system of claim 20, wherein the display surfaces comprise one or more of a windshield, a window, a mirror, a pillar, a side panel of a door, a headrest, a dashboard, a console, a seat, or any portion thereof, of the vehicle.

26. (canceled)

27. The vehicle projection system of claim 20, further comprising an eye location tracking device coupled to the projector device, the eye location tracking device configured to determine a viewing angle for at least one passenger in the vehicle, wherein the projector device is movable to provide the display image based on the determined viewing angle.

28. The vehicle projection system of claim 20, wherein the projector device is coupled to a vehicle onboard computer to receive one or more items of data related to the vehicle from the vehicle onboard computer for display in the display image.

29. (canceled)

30. (canceled)
